(19) United States
(12) Patent Application Publication
(10) Pub. No.: US 2024/0303103 A1
(43) Pub. Date: Sep. 12, 2024

(54) VEHICLE-MOUNTED COMPUTER, COMPUTER EXECUTION METHOD, AND COMPUTER PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Koji YASUDA, Yokkaichi-shi, Mie (JP)

(21) Appl. No.: 18/272,731

(22) PCT Filed: Dec. 28, 2021
(86) PCT No.: PCT/JP2021/048917

§ 371 Date: Jul. 17, 2023

(30) Foreign Application Priority Data
Jan. 18, 2021 (JP) 2021-005988

(51) Int. Cl. G06F 9/455; B60R 16/023

(52) U.S. Cl. CPC G06F 9/45558; B60R 16/023; G06F 2009/45591

(57) ABSTRACT

A vehicle-mounted computer, that includes a physical resource including a processor having a register and a plurality of physical devices each having a register and generates a plurality of virtual devices by allocating the physical resource through time-division, saves a register value of the processor related to a first virtual device and restores the register value of the processor related to a second virtual device when switching from the first virtual device to the second virtual device, determines whether or not it is necessary to change a register value of the physical device to be used by the second virtual device when switching from the first virtual device to the second virtual device, and restores the register value of the physical device related to the second virtual device in the physical device if it is determined that change is necessary.

### CROSS-REFERENCE TO RELATED APPLICATIONS

This application is the U.S. national stage of PCT/JP2021/048917 filed on Dec. 28, 2021, which claims priority of Japanese Patent Application No. JP 2021-005988 filed on Jan. 18, 2021, the contents of which are incorporated herein.

### TECHNICAL FIELD

The present disclosure relates to a vehicle-mounted computer, a computer execution method, and a computer program.

### BACKGROUND

A vehicle is equipped with a plurality of electronic control units (hereinafter referred to as ECUs) connected to a vehicle-mounted network. In recent years, accompanying higher functionality of vehicles, such as the introduction of advanced driver-assistance systems (ADAS), automatic driving technology, and artificial intelligence technology, the number of ECUs installed in vehicles is increasing. Also, close cooperation between ECUs prepared for each function such as a power train system, a body system, and a chassis system is becoming necessary.

In view of this, consideration has been given to integrating and aggregating the functions of a plurality of ECUs installed for each function, into a specific vehicle-mounted computer. The vehicle-mounted computer integrates the functions of various ECUs by generating each ECU as a virtual device using virtualization technology, for example, and executing a program for realizing the function of each ECU on the virtual device (e.g., JP 2011-198346A and JP 2011-118578A).

The processor of the vehicle-mounted computer schedules tasks relating to virtual devices that reproduce a plurality of ECUs and programs on the virtual devices, and switches and executes the tasks related to each virtual device.

In embedded processors such as those installed in ECUs, when switching between tasks related to a plurality of virtual devices, the vehicle-mounted computer not only requires switching of context, which is the state of the processor, but also needs to manage and switch the state of a plurality of physical devices such as an SCB (System Control Block), an MMU (Memory Protection Unit), and other peripherals.

However, in the prior art, no consideration was given to the processing load related to physical device state management and context switching, resulting in unnecessary processing load.

An object of the present disclosure is to provide a vehicle-mounted computer, a computer execution method, and a computer program capable of reducing the state switching processing load for a plurality of physical devices accompanying task context switching related to a plurality of virtual devices.

### SUMMARY

A vehicle-mounted computer according to one aspect of the present disclosure is a vehicle-mounted computer including a physical resource including a processor having a register and a plurality of physical devices each having a register, the vehicle-mounted computer generating a plurality of virtual devices by allocating the physical resource through time-division, in which the processor saves a register value of the processor related to a first virtual device among the virtual devices and restores a register value of the processor related to a second virtual device among the virtual devices when switching from the first virtual device to the second virtual device, determines whether or not it is necessary to change a register value of the physical device to be used by the second virtual device when switching from the first virtual device to the second virtual device, and restores the register value of the physical device related to the second virtual device in the physical device if it is determined that change is necessary.

A computer execution method according to one aspect of the present disclosure is a computer execution method to be executed by a vehicle-mounted computer that includes a physical resource including a processor having a register and a plurality of physical devices each having a register, and generates a plurality of virtual devices by allocating the physical resource through time-division, the method including: saving a register value of the processor related to a first virtual device among the virtual devices and restoring a register value of the processor related to a second virtual device among the virtual devices when switching from the first virtual device to the second virtual device; determining whether or not it is necessary to change a register value of the physical device to be used by the second virtual device when switching from the first virtual device to the second virtual device; and restoring the register value of the physical device related to the second virtual device in the physical device if it is determined that change is necessary.

A computer program according to one aspect of the present disclosure is a computer program for causing a vehicle-mounted computer, that includes a physical resource including a processor having a register and a plurality of physical devices each having a register and generates a plurality of virtual devices by allocating the physical resource through time-division, to execute the following processing: saving a register value of the processor related to a first virtual device among the virtual devices and restoring a register value of the processor related to a second virtual device among the virtual devices when switching from the first virtual device to the second virtual device; determining whether or not it is necessary to change a register value of the physical device to be used by the second virtual device when switching from the first virtual device to the second virtual device; and restoring the register value of the physical device related to the second virtual device if it is determined that change is necessary.

Note that the present application can be realized not only as a vehicle-mounted computer having such a characteristic processor, but also as a computer execution method having such characteristic processing as steps, or as a computer program for causing a computer to execute such a step. Also, the present application can be realized as a semiconductor integrated circuit that realizes part or all of the vehicle-mounted computer, or another system including the vehicle-mounted computer.

### Advantageous Effects

According to the present disclosure, it is possible to provide a vehicle-mounted computer, a computer execution method, and a computer program capable of reducing the load of state switching processing for a plurality of physical devices accompanying task context switching related to a plurality of virtual devices.

### BRIEF DESCRIPTION OF DRAWINGS

FIG. 1 is a block diagram showing a network configuration of a vehicle-mounted communication system.

FIG. 2 is a block diagram showing a configuration example of a vehicle-mounted communication system.

FIG. 3 is a block diagram showing a configuration example of a processor.

FIG. 4 is a conceptual diagram of a virtual device generated by a vehicle-mounted computer.

FIG. 5 is a conceptual diagram showing an example of a device configuration table.

FIG. 6A is a conceptual diagram showing an example of a setting value of a second physical device.

FIG. 6B is a conceptual diagram showing an example of a setting value of a second physical device.

FIG. 7 is a functional block diagram relating to context switching processing according to the first embodiment.

FIG. 8 is a flow chart showing a context switching processing procedure of the first embodiment.

FIG. 9 is a conceptual diagram showing task switching processing according to the first embodiment.

FIG. 10 is a functional block diagram relating to context switching processing according to a second embodiment.

FIG. 11 is a flow chart showing a context switching processing procedure according to the second embodiment.

FIG. 12 is a functional block diagram relating to context switching processing of a third embodiment.

FIG. 13 is a flow chart showing a context switching processing procedure of the third embodiment.

FIG. 14 is a conceptual diagram showing task switching processing according to the third embodiment.

### DETAILED DESCRIPTION OF PREFERRED EMBODIMENTS

First, embodiments of the present disclosure are listed and described. In addition, at least some of the embodiments described below may be combined as appropriate.

A vehicle-mounted computer according to one aspect of the present disclosure is a vehicle-mounted computer including a physical resource including a processor having a register and a plurality of physical devices each having a register, the vehicle-mounted computer generating a plurality of virtual devices by allocating the physical resource through time-division, in which the processor saves a register value of the processor related to a first virtual device among the virtual devices and restores a register value of the processor related to a second virtual device among the virtual devices when switching from the first virtual device to the second virtual device, determines whether or not it is necessary to change a register value of the physical device to be used by the second virtual device when switching from the first virtual device to the second virtual device, and restores the register value of the physical device related to the second virtual device in the physical device if it is determined that change is necessary.

In this aspect, the processor saves and restores the register value of the processor when switching from the first virtual device to the second virtual device in order to allocate the physical resource through time-division. Also, when switching from the first virtual device to the second virtual device, it is basically necessary to perform a setting change of the register value of the physical device as well, but the processor according to the present aspect determines whether or not it is necessary to change the register value used by the first and second virtual devices, and restores the register value of the physical device related to the second virtual device if it is determined that change is necessary. That is, the processing for changing the register value of a physical device that does not require a setting change is not executed.

Accordingly, it is possible to reduce the processing load of switching the states of a plurality of physical devices accompanying task context switching related to a plurality of virtual devices.

The vehicle-mounted computer according to one aspect of the present disclosure preferably has a configuration further including a device configuration table including register values to be set in the physical devices to be used by each of the plurality of virtual devices, in which the processor determines whether or not it is necessary to change the register value of the physical device to be used by the second virtual device by referring to the device configuration table when switching from the first virtual device to the second virtual device, and restores the register value of the physical device to be used by the second virtual device in the physical device if it is determined that change is necessary.

In this aspect, the processor can determine whether or not it is necessary to change the register values when switching between the first and second virtual devices, by referring to the device configuration table including the register values to be set in the physical devices used by each of the plurality of virtual devices.

The vehicle-mounted computer according to one aspect of the present disclosure preferably has a configuration in which if it is determined that it is not necessary to change the register value of the physical device, the processor skips processing for restoring the register value of the physical device.

In this aspect, if it is determined that it is not necessary to change the register values to be used by the first and second virtual devices when switching from the first virtual device to the second virtual device, the processor skips the processing for changing the register value of the physical device that does not require a setting change.

Accordingly, it is possible to reduce the processing load of switching the states of a plurality of physical devices accompanying task context switching related to a plurality of virtual devices.

The vehicle-mounted computer according to one aspect of the present disclosure preferably has a configuration in which the processor saves a register value of the physical device to be used by the first virtual device, and restores the register value of the physical device to be used by the second virtual device, when switching from the first virtual device to the second virtual device.

In this aspect, when switching the register value of the physical device from the first virtual device to the second virtual device, it is possible to selectively save and restore the register value of the physical device that requires a setting change.

Accordingly, it is possible to reduce the processing load of switching the states of a plurality of physical devices accompanying task context switching related to a plurality of virtual devices.

The vehicle-mounted computer according to one aspect of the present disclosure preferably has a configuration in which the processor refers to the device configuration table and determines a switching order of the plurality of virtual devices that minimizes the number of changes to the register values of the physical devices, and the processor controls operation of the plurality of virtual devices in the determined order.

In this aspect, a plurality of virtual devices can be switched in the order that minimizes the number of changes to the register values of the physical device.

Accordingly, it is possible to reduce the processing load of switching the states of a plurality of physical devices accompanying task context switching related to a plurality of virtual devices.

A computer execution method according to an aspect of the present disclosure is a computer execution method to be executed by a vehicle-mounted computer that includes a physical resource including a processor having a register and a plurality of physical devices each having a register, and generates a plurality of virtual devices by allocating the physical resource through time-division, the method including: saving a register value of the processor related to a first virtual device among the virtual devices and restoring a register value of the processor related to a second virtual device among the virtual devices when switching from the first virtual device to the second virtual device; determining whether or not it is necessary to change a register value of the physical device to be used by the second virtual device when switching from the first virtual device to the second virtual device; and restoring the register value of the physical device related to the second virtual device in the physical device if it is determined that change is necessary.

According to this aspect, similarly to the aspect (1), it is possible to reduce the processing load of switching the states of a plurality of physical devices accompanying task context switching related to a plurality of virtual devices.

A computer program according to an aspect of the present disclosure is a computer program for causing a vehicle-mounted computer, that includes a physical resource including a processor having a register and a plurality of physical devices each having a register and generates a plurality of virtual devices by allocating the physical resource through time-division, to execute the following processing: saving a register value of the processor related to a first virtual device among the virtual devices and restoring a register value of the processor related to a second virtual device among the virtual devices when switching from the first virtual device to the second virtual device; determining whether or not it is necessary to change a register value of the physical device to be used by the second virtual device when switching from the first virtual device to the second virtual device; and restoring the register value of the physical device related to the second virtual device if it is determined that change is necessary.

According to this aspect, similarly to the aspect (1), it is possible to reduce the processing load of switching the states of a plurality of physical devices accompanying task context switching related to a plurality of virtual devices.

### DETAILED EMBODIMENTS OF THE DISCLOSURE

A vehicle-mounted computer, a computer execution method, and a computer program included in a vehicle-mounted system according to an embodiment of the present disclosure will be described below with reference to the drawings. Note that the present disclosure is not limited to these examples, but is indicated by the claims, and all modifications within the meaning and range of equivalency to the claims are intended to be encompassed therein. In addition, at least part of the embodiments described below may be combined as appropriate.

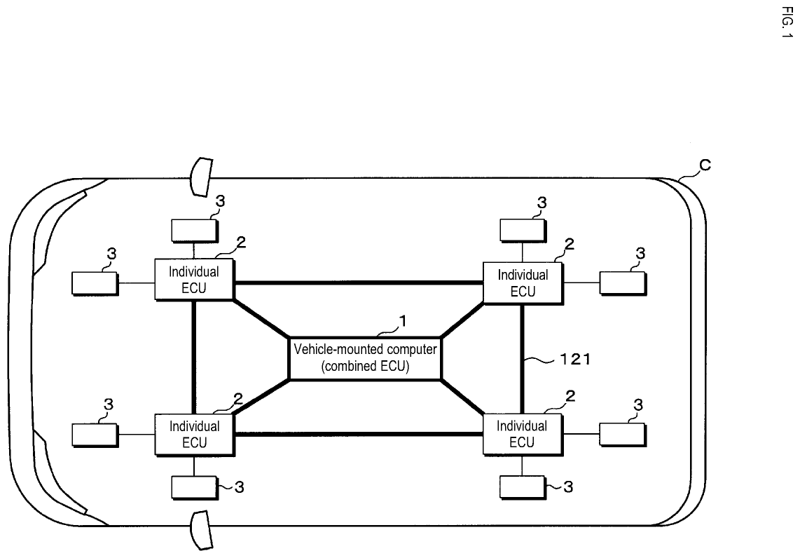

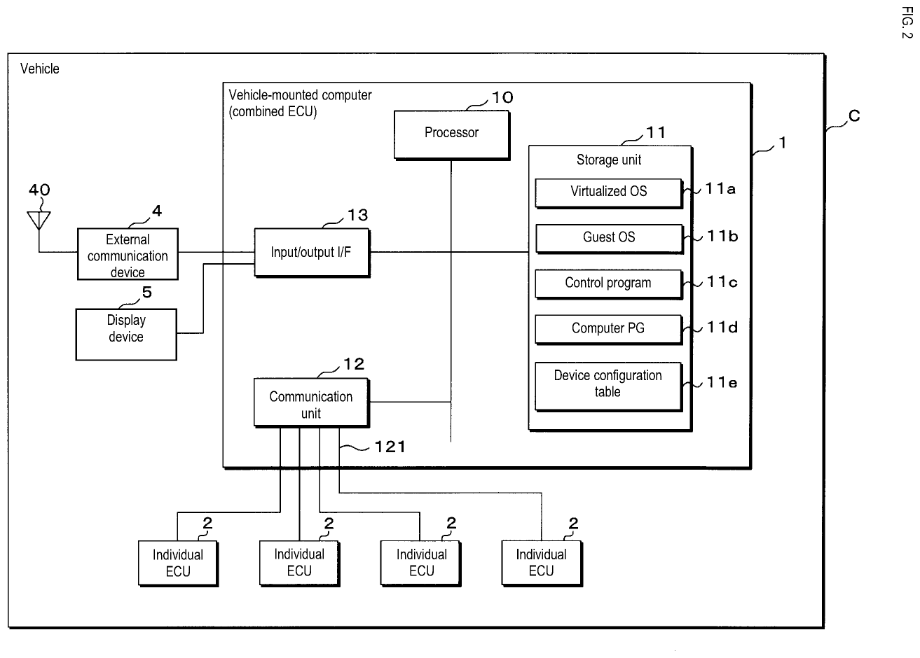

Hereinafter, the present disclosure will be specifically described based on the drawings showing the embodiments thereof. FIG. 1 is a block diagram showing a network configuration of a vehicle-mounted communication system, and FIG. 2 is a block diagram showing a configuration example of the vehicle-mounted communication system.

The vehicle-mounted communication system according to the first embodiment includes a vehicle-mounted computer 1, a plurality of individual ECUs 2, devices 3 connected to the individual ECUs 2, an external communication device 4, and a display device 5. The plurality of individual ECUs 2 are respectively connected to the vehicle-mounted computer 1 via vehicle-mounted communication lines 121.

The vehicle-mounted computer 1 includes a processor 10, a storage unit 11, a communication unit 12, and an input/output I/F 13. The vehicle-mounted computer 1 is also called an integrated ECU.

The storage unit 11 is a non-volatile memory device such as flash memory or EEPROM (Electrically Erasable Programmable Read Only Memory). The storage unit 11 stores a virtualized operating system (virtualized OS) 11a, a guest OS 11b, a control program 11c, a computer program (computer PG) 11d according to the first embodiment, a device configuration table 11e, and various other data necessary for the operation of the processor 10.

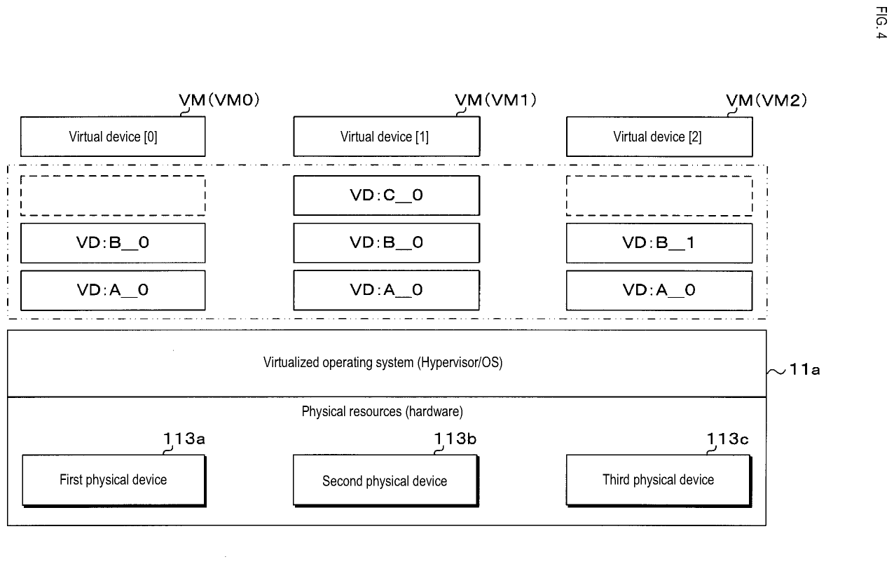

The virtualized operating system 11a is Hypervisor, for example. The virtualized operating system 11a has a function of constructing a plurality of virtual environments operating as virtual devices VM (see FIG. 4) on the virtualized operating system 11a. A virtual environment, that is, a virtual device VM includes a virtual processor, a virtual storage unit, a virtual communication unit, and the like, which are obtained by allocating physical resources including the processor 10, the storage unit 11, the communication unit 12, and the like through time-division, and operates as hardware of a virtual ECU.

The guest OS 11b is an OS for operating the virtual device VM generated by the virtualized operating system 11a. The guest OS 11b is installed in a virtual device VM having virtual hardware and functions as a basic OS of the virtual device VM. The guest OS 11b is, for example, an AUTOSAR (registered trademark) OS, Linux (registered trademark), Android (registered trademark), QNX (registered trademark), Ubuntu (registered trademark), or the like.

The control program 11c is a program that runs on the guest OS 11b of each virtual device VM, and is for reproducing the functions of an ECU (not shown) integrated into the vehicle-mounted computer 1.

The virtual device VM reproduces the functions of a real physical ECU by causing the guest OS 11b and control program 11c to run on these pieces of virtual hardware. That is, the virtual device VM operates like an ECU connected to the vehicle-mounted communication line 121.

The computer program 11d is a program for efficiently switching tasks related to the virtual device VM and the control program 11c. Note that the computer program 11d may also be incorporated in the virtualization OS 11a. Details of the device configuration table 11e will be described later.

Note that the above-described various programs may also be written in the storage unit 11 at the manufacturing stage of the vehicle-mounted computer 1, or the above-described various programs distributed from an external server device (not shown) may be acquired by the vehicle-mounted computer 1 and written in the storage unit 11. Also, the above-described various programs recorded in a computer-readable recording medium such as a memory card or an optical disk may be read out by the vehicle-mounted computer 1 and written in the storage unit 11.

As described above, the above-described various programs may also be provided in the form of distribution via a network, or may be provided in the form of being recorded on a recording medium.

The processor 10 reads out and executes the virtualized operating system 11a, the guest OS 11b, the control program 11c, the computer program 11d, the device configuration table 11e, and the like stored in the storage unit 11, thereby performing various arithmetic processing and implementing the computer execution method according to the first embodiment.

The communication unit 12 is, for example, an Ethernet (registered trademark) PHY unit that performs communication conforming to a communication protocol such as 100BASE-T1 or 1000BASE-T1. Note that Ethernet (registered trademark) is an example, and the communication unit 12 may be a communication circuit that performs communication with a communication protocol such as a CAN (Controller Area Network), CAN-FD, FlexRay (registered trademark), CXPI (Clock Extension Peripheral Interface), LIN (Local Interconnect Network), or the like.

A plurality of individual ECUs 2 are connected to the communication unit 12 via a vehicle-mounted communication line 121 conforming to the above-described communication protocol. An individual ECU 2 is an electronic control unit that controls the operation of the devices 3 provided in specific areas such as the front right, front left, rear right, and rear left of the vehicle C, as shown in FIG. 1, for example. The device 3 is various sensors such as a vehicle-mounted camera that captures images outside the vehicle, a LIDAR (Light Detection And Ranging), and an in-vehicle camera. The device 3 is an actuator that operates a door locking/unlocking device, a door mirror, a seat, and the like. The device 3 may also be an audio device that outputs images and audio for an entertainment system. The device 3 may also be an electronic control unit.

Control of the device 3 by the individual ECUs 2 and various arithmetic processing can be executed on the vehicle-mounted computer 1 side. That is, the vehicle-mounted computer 1 can reproduce the ECU that controls the operation of the device 3 as a virtual device VM.

The input/output I/F 13 is an interface for communicating with the external communication device 4, the display device 5, and the like. The external communication device 4 and the display device 5 are connected to the input/output I/F 13 via a wire harness such as a serial cable.

The external communication device 4 includes an antenna 40 for wireless communication, and is a communication device that performs wireless communication through an Internet communication network such as WiFi (registered trademark) and mobile communication networks such as 3G, LTE (registered trademark), 4G, and 5G. The vehicle-external communication device 4 is, for example, a telematics control unit (TCU). Note that although the first embodiment describes the vehicle-external communication device 4 and the vehicle-mounted computer 1 as separate units, the vehicle-mounted computer 1 may also be configured to have the configuration and functions of the external communication device 4.

The display device 5 is, for example, an HMI (Human Machine Interface) device such as a car navigation display. The display device 5 displays data or information output from the processor 10 of the vehicle-mounted computer 1 via the input/output I/F 13.

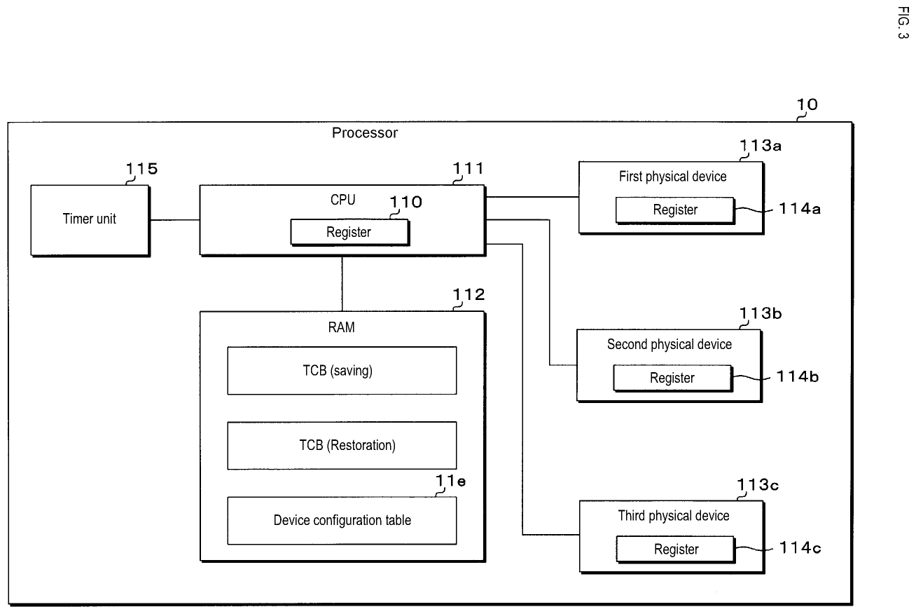

FIG. 3 is a block diagram showing a configuration example of the processor 10. The processor 10 includes a CPU (Central Processing Unit) 111, a RAM (Random Access Memory) 112, a first physical device 113a, a second physical device 113b, a third physical device 113c, and a timer unit 115, which are arithmetic units.

The first to third physical devices 113a, 113b, and 113c are, for example, SCBs (System Control Blocks), MMUs (Memory Protection Units), and other peripherals. The first to third physical devices 113a, 113b, and 113c have at least registers 114a, 114b, and 114c for controlling the state of each device.

Note that the number of physical devices provided in the processor 10 is not particularly limited.

The RAM 112 is an example of a volatile memory device. The RAM 112 of the processor 10 that generated the virtual device VM stores a TCB (Task Control Block) and a device configuration table 11e.

The TCB contains context information related to the virtual device VM. The context information includes the state of the CPU 111 when a certain virtual device VM is operating and executing the control program 11c, that is, the values of the registers 110 of the CPU 111 (hereinafter referred to as the register values of the CPU 111 as appropriate). For example, the RAM 112 stores context information for two virtual devices VM before and after context switching occurs. That is, the RAM 112 stores context information saved from the registers 110 of the CPU 111 at the time of context switching and context information to be restored to the registers 110 of the CPU 111. Note that when the three virtual devices VM are to be operated, the RAM 112 stores the context information of the CPU 111 at the time when each virtual device VM was being controlled.

The device configuration table 11e will be described. In this embodiment, a case is described in which the values set in the registers 114a, 114b, and 114c of the first to third physical devices 113a, 113b, and 113c when each virtual device VM operates (hereinafter referred to as the register values of the first to third physical devices 113a, 113b, and 113c) are fixed. The RAM 112 in FIG. 3 shows a state in which the device configuration table 11e stored in the storage unit 11 has been read out and stored.

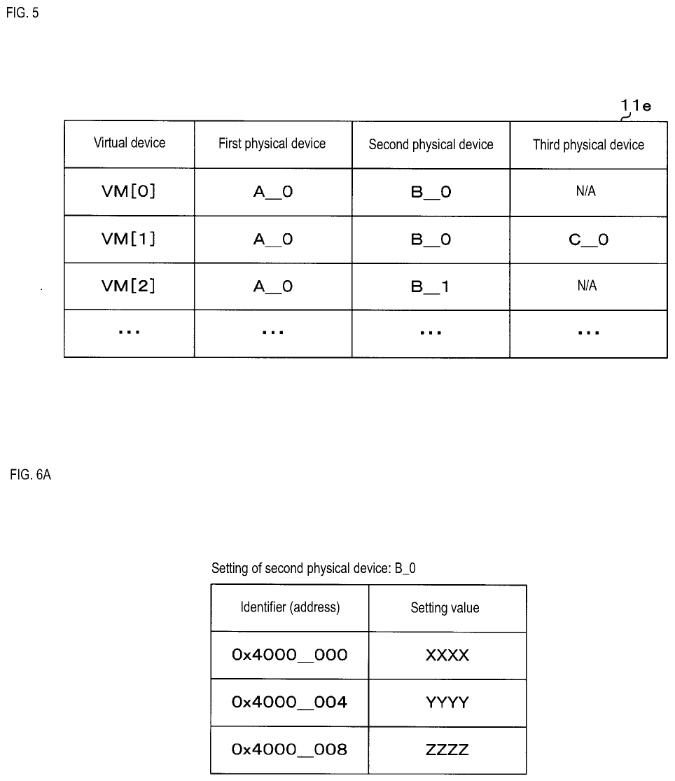

FIG. 4 is a conceptual diagram of the virtual device VM generated by the vehicle-mounted computer 1, and FIG. 5 is a conceptual diagram showing an example of the device configuration table 11e. The virtualized operating system 11a creates three virtual devices VM, as shown in FIG. 4, for example. The virtual device VM uses all or some of the first to third physical devices 113a, 113b, and 113c. The values set in the registers 114a, 114b, and 114c of the first to third physical devices 113a, 113b, and 113c differ depending on the virtual device VM. The three blocks shown below the blocks representing the first to third physical devices 113a, 113b, and 113c indicate the values set in, in order starting from the bottom, the register 114a of the first physical device 113a, the register 114b of the second physical device 113b, and the register 114c of the third physical device 113c.

In FIG. 4, “VD:A_0” indicates the value “A_0” set in the register 114a of the first physical device 113a. “VD:B_0” and “VD:B_1” indicate the values “B_0” and “B_1” set in the register 114b of the second physical device 113b. “VD:C_0” indicates the value “C_0” set in the register 114c of the third physical device 113c. A blank block indicated by a dashed line indicates that the third physical device 113c is not used.

Note that although three virtual devices VM, . . . are illustrated in FIG. 4, the number of virtual devices VM, . . . that operate on the virtualized operating system 11a is not limited to three.

The device configuration table 11e shown in FIG. 5 is a table including a “virtual device” column, a “first physical device” column, a “second physical device” column, and a “third physical device” column. The “virtual device” column stores identification data VM[0], VM[1], VM[2], . . . for identifying each of a plurality of virtual devices VM. Hereinafter, the virtual device VM indicated by the identification data VM[0] is referred to as a virtual device VM0, the virtual device VM indicated by the identification data VM[1] is referred to as a virtual device VM1, and the virtual device VM indicated by the identification data VM[2] is referred to as a virtual device VM2.

The “first physical device” column stores whether or not the corresponding virtual device VM uses the first physical device 113a, and if so, the value set in the register 114a. In the example shown in FIG. 5, all of the virtual devices VM use the first physical device 113a, and the value set in the register 114a is the same “A_0”.

The “second physical device” column stores whether or not the corresponding virtual device VM uses the second physical device 113b, and if so, the value set in the register 114b. In the example shown in FIG. 5, all of the virtual devices VM use the second physical device 113b, the values set in the registers 114a and 114b of the virtual devices VM0 and VM1 are “B_0”, and the value set in the register 114c of the virtual device VM2 is “B_1”.

The “third physical device” column stores whether or not the corresponding virtual device VM uses the third physical device 113c, and if so, the value set in the register 114c. In the example shown in FIG. 5, one virtual device VM2 uses the third physical device 113c, and the value set in the register 114c of the virtual device VM2 is “C_0”. “Not applicable” indicates that the third physical device 113c is not used.

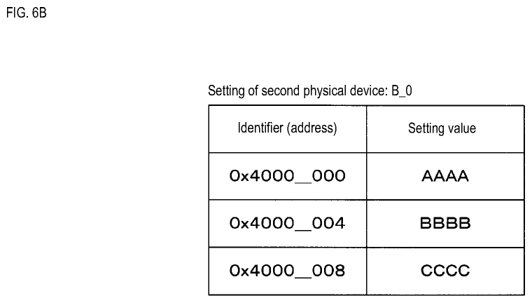

FIGS. 6A and 6B are conceptual diagrams showing an example of setting values of the second physical device 113b. FIG. 6A shows the value “B_0” set in the register 114b of the second physical device 113b, and FIG. 6B shows the value “B_1” set in the register 114b of the second physical device 113b. “Identifier (address)” indicates the address of the register 114b, and “setting value” is the numerical value set in the register 114b specified by each address.

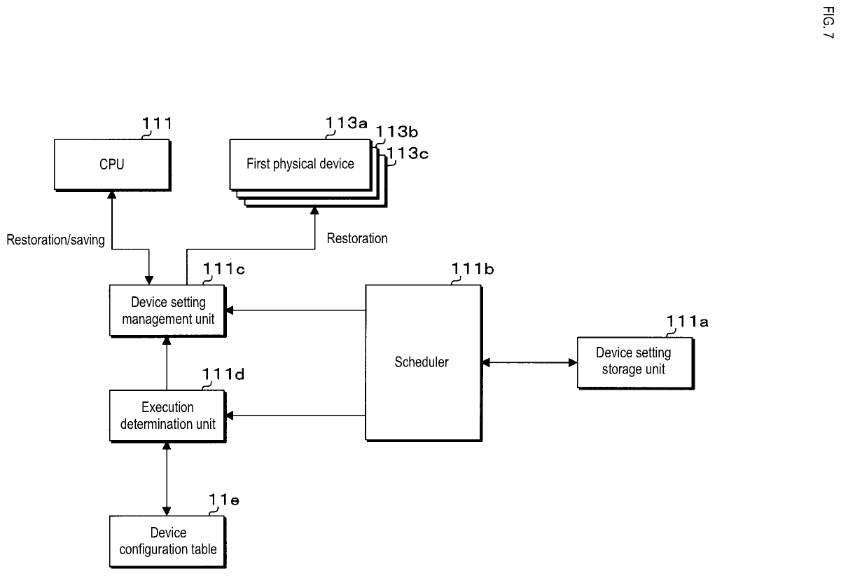

FIG. 7 is a functional block diagram related to context switching processing according to the first embodiment. The vehicle-mounted computer 1 includes a device setting storage unit 111a, a scheduler 111b, a device setting management unit 111c, and an execution determination unit 111d as functional units.

The device setting storage unit 111a is a functional unit that stores a TCB or context information. The device setting storage unit 111a stores the register values of the CPU 111 related to the virtual devices VM as context information. More specifically, when switching the virtual device VM to be operated by the CPU 111, the device setting storage unit 111a saves the value of the register 110 of the CPU 111 that was controlling the one operating virtual device VM, and stores the value as context information.

In response to an inquiry from the scheduler 111b, the device setting storage unit 111a returns the context information stored in the device setting storage unit 111a, that is, the value of the register 110 of the CPU 111 related to the virtual device VM to be operated next due to the context switching. The RAM 112 is the main hardware that constitutes the device setting storage unit 111a.

The scheduler 111b is a functional unit that manages allocation and switching of hardware resources of the CPU 111 for the virtual devices VM. The scheduler 111b cyclically switches the virtual devices VM at a predetermined period, and the CPU 111 executes processing related to each virtual device VM. That is, the scheduler 111b of the first embodiment switches in the order of virtual device VM0, virtual device VM1, virtual device VM2, virtual device VM1, . . . . The switching order is fixed. The processing related to the virtual device VM includes processing for emulating the virtual processor, virtual storage unit, virtual communication unit, and the like included in the virtual device VM, processing for operating the guest OS 11b and the control program 11c, and the like.

Hereinafter, the information indicating the virtual device VM before the context switching, that is, the operating virtual device VM, is referred to as first virtual device information, and the information indicating the virtual device VM after the context switching, that is, the virtual device VM to be operated next, is referred to as second virtual device information.

The scheduler 111b provides the first virtual device information and the second virtual device information to the execution determination unit 111d. Also, the scheduler 111b uses the second virtual device information to inquire about the context information of the virtual device VM indicated by the second virtual device information, and acquires the context information output from the device setting storage unit 111a. The scheduler 111b provides the acquired context information to the device setting management unit 111c.

Note that the CPU 111 and the timer unit 115 are the main hardware constituting the scheduler 111b.

The execution determination unit 111d acquires the first virtual device information and the second virtual device information provided from the scheduler 111b, refers to the device configuration table 11e based on the acquired first and second virtual device information, and reads out the set values of the registers 114a, 114b, and 114c of the first to third physical devices 113a, 113b, and 113c associated with the virtual devices VM before and after context switching. Then, when switching the virtual devices VM, the execution determination unit 111d determines whether or not the setting values of the registers 114a, 114b, and 114c of the first to third physical devices 113a, 113b, and 113c need to be changed, and provides the device information based on the determination result to the device setting manager.

If it is determined that there is no need to change the setting values of the registers 114a, 114b, and 114c of the first to third physical devices 113a, 113b, and 113c, the device information includes information indicating that setting change is unnecessary. If it is determined that the setting values of the registers 114a, 114b, and 114c of the first to third physical devices 113a, 113b, and 113c need to be changed, the device information includes identifiers and setting values for the registers 114a, 114b, and 114c of the first to third physical devices 113a, 113b, and 113c for which a change of setting values is needed. Note that the CPU 111 is the main hardware that constitutes the execution determination unit 111d.

The device setting management unit 111c acquires the context information provided from the scheduler 111b, saves the register values of the CPU 111 and restores the acquired context information. That is, the device setting management unit 111c stores the register values of the CPU 111 before the context switching in the device setting storage unit 111a as context information of the CPU 111 related to the operating virtual device VM, and then sets the context information acquired from the scheduler 111b, that is, the register values of the CPU 111 related to the virtual device VM after the context switching, in the registers 110 of the CPU 111.

The device setting management unit 111c acquires the device information provided from the execution determination unit 111d, and if the acquired device information indicates that the setting change is unnecessary, the device setting management unit 111c ends the processing related to context switching without performing a setting change of the registers 114a, 114b, and 114c of the first to third physical devices 113a, 113b, and 113c. The CPU 111 immediately starts executing the processing related to the virtual device VM after the context switching without rewriting the registers 114a, 114b, and 114c of the first to third physical devices 113a, 113b, and 113c.

On the other hand, if the acquired device information indicates the identifiers and setting values of the registers 114a, 114b, and 114c of the specific first to third physical devices 113a, 113b, and 113c for which a setting change is needed, the device setting management unit 111c changes the setting values of the registers 114a, 114b, and 114c of the first to third physical devices 113a, 113b, and 113c using the identifiers and setting values. The CPU 111 rewrites the registers 110 of the CPU 111 and the registers 114a, 114b, and 114c of the specific first to third physical devices 113a, 113b, and 113c for which a setting change is needed, and starts executing the processing related to the virtual device VM after the context switching.

Note that the CPU 111 is the main hardware that constitutes the device setting management unit 111c.

As described above, according to the device setting storage unit 111a, the scheduler 111b, the device setting management unit 111c, and the execution determination unit 111d, when the hardware resources of the CPU 111 are allocated by periodically switching the virtual devices VM, it is possible to efficiently switch the states of the first to third physical devices 113a, 113b, and 113c by specifying the first to third physical devices 113a, 113b, and 113c that require a setting change, and changing the setting values of the registers 114a, 114b, and 114c of the specific first to third physical devices 113a, 113b, and 113c that require a setting change.

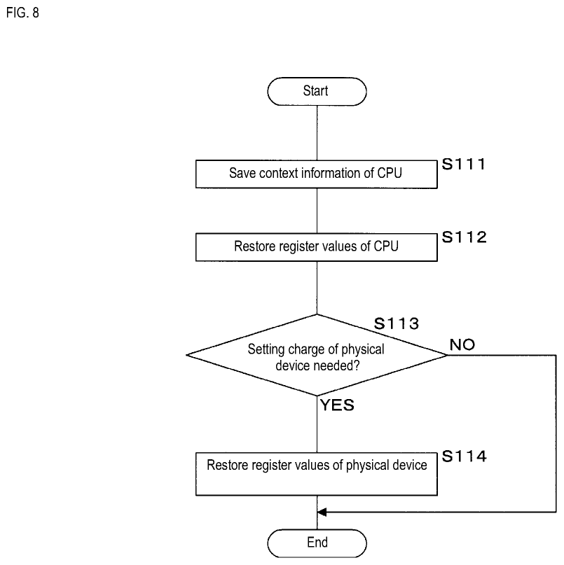

FIG. 8 is a flow chart showing a context switching processing procedure according to the first embodiment. The processor 10 executes the following processing at a predetermined period for switching the virtual devices VM. The processor 10 saves the context information of the CPU 111 to the RAM 112 (step S111). Specifically, the CPU 111 causes the RAM 112 to store the context information in association with the information indicating the currently-operating virtual device VM.

Then, the processor 10 restores the context information of the CPU 111 saved in the RAM 112, that is, the register value of the CPU 111 related to the virtual device VM to be operated next (step S112).

Next, the processor 10 refers to the device information table and determines whether or not it is necessary to change the setting values of the registers 114a, 114b, and 114c of the first to third physical devices 113a, 113b, and 113c after the context switching (step S113). Specifically, the processor 10 determines whether or not the first to third physical devices 113a, 113b, and 113c to be used by the virtual devices VM will be different after the context switching by comparing the physical devices and setting values used by the virtual devices VM before the context switching and the physical devices and setting values used by the virtual devices VM after the context switching, and if the virtual devices VM will be different, the processor 10 determines whether or not the setting values of the registers 114a, 114b, and 114c will be different.

If it is determined that the first to third physical devices 113a, 113b, and 113c do not require a setting change (step S113: NO), the processor 10 ends the processing. If it is determined that any one of the first to third physical devices 113a, 113b, and 113c requires a setting change (step S113: YES), the processor 10 restores the register values of the first to third physical devices 113a, 113b, and 113c to be used by the virtual devices VM to be operated after the context switching in the registers 114a, 114b, and 114c of the first to third physical devices 113a, 113b, and 113c that require a setting change (step S114).

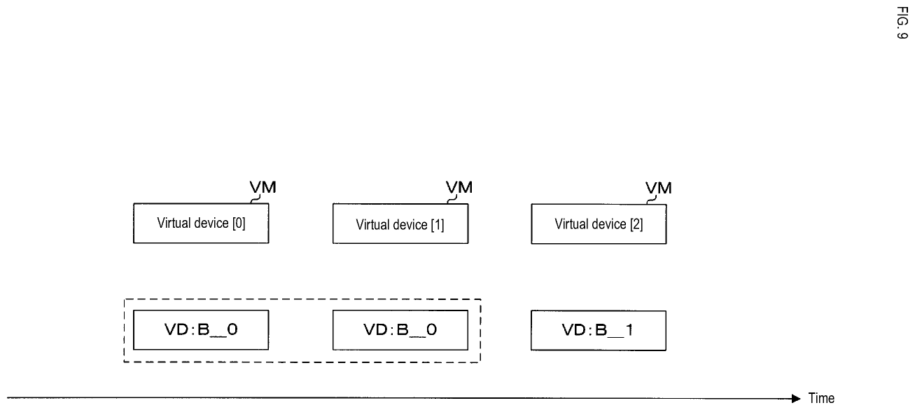

FIG. 9 is a conceptual diagram showing task switching processing according to the first embodiment. Horizontal arrows indicate the flow of time, and indicate that the virtual device VM0, the virtual device VM1, and the virtual device VM2 are switched in this order to operate. The blocks shown below the blocks of the virtual devices VM indicate the setting value of the second physical device 113b that requires a setting change. Note that the setting values of the first physical device 113a and the third physical device 113c are not shown in FIG. 9 because they do not require a setting change.

When switching from the virtual device VM0 to the virtual device VM1, the setting value of the second physical device 113b remains “B_0” after the context switching, and therefore the processor 10 does not change the setting value of the register 114b of the second physical device 113b.

When switching from the virtual device VM1 to the virtual device VM2, the setting value of the second physical device 113b is different after the context switching, and therefore the processor 10 sets the setting value “B_1” in the register 114b of the second physical device 113b.

In this manner, if it is unnecessary to change the register values of the first to third physical devices 113a, 113b, and 113c after the context switching, the processor 10 can skip the setting changes of the first to third physical devices 113a, 113b, and 113c, and therefore the processor 10 can effectively perform context switching of the virtual device VM. In other words, the processing load of the processor 10 relating to context switching can be reduced by omitting the unnecessary processing of inputting setting values to the registers 114a, 114b, and 114c of the first to third physical devices 113a, 113b, and 113c that do not require a setting change.

As described above, according to the vehicle-mounted computer 1, the computer execution method, and the computer program 11d according to the first embodiment, it is possible to reduce the processing load of switching the states of the plurality of first to third physical devices 113a, 113b, and 113c accompanying the task context switching related to the plurality of virtual devices VM.

If it is determined that it is not necessary to change the register values, the processor 10 skips the processing of changing the register values of the first to third physical devices 113a, 113b, and 113c that do not require a setting change, and therefore it is possible to reduce the processing load of switching the states of the plurality of first to third physical devices 113a, 113b, and 113c accompanying the task context switching related to the plurality of virtual devices VM.

Also, the processor can determine whether or not it is necessary to change the register values when switching the virtual device VM by referring to the device configuration table 11e including register values to be set in the first to third physical devices 113a, 113b, and 113c used by each of the plurality of virtual devices VM.

Note that in the present first embodiment, an example in which a virtual environment is constructed using the Hypervisor-type virtualized operating system 11a has been described, but the virtual environment may also be constructed using host OS-type virtualized software, that is, virtualized software that runs on a basic OS.

### Second Embodiment

The vehicle-mounted computer 1, the computer execution method, and the computer program 11d according to the second embodiment differ from those of the first embodiment in that the register values of the first to third physical devices 113a, 113b, and 113c dynamically change according to the situation. Other configurations of the vehicle-mounted computer 1 and the like are the same as those of the vehicle-mounted computer 1 and the like according to the first embodiment, and therefore the same constituent elements are denoted by the same reference signs, and detailed description thereof is omitted.

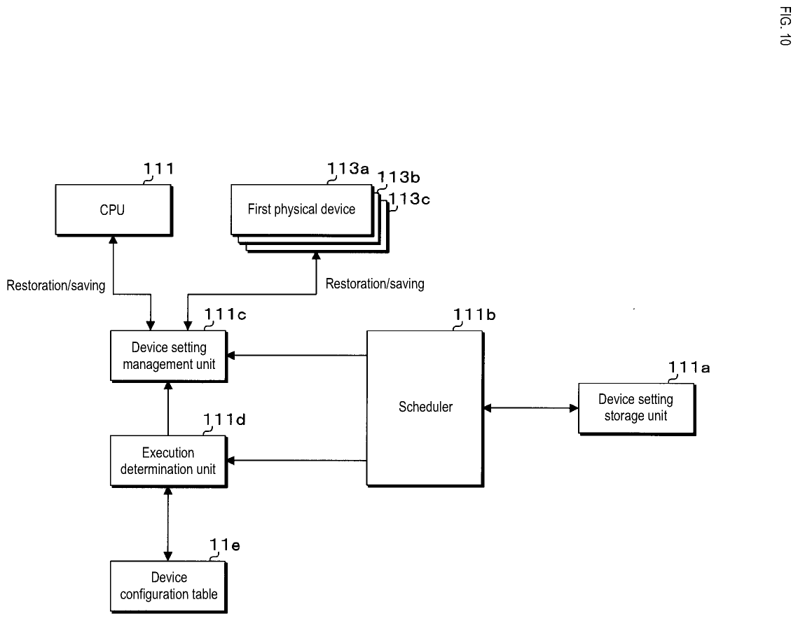

FIG. 10 is a functional block diagram relating to context switching processing according to the second embodiment. The vehicle-mounted computer 1 includes a device setting storage unit 111a, a scheduler 111b, a device setting management unit 111c, and an execution determination unit 111d as functional units, as in the first embodiment.

However, when switching the virtual device VM, the device management unit saves not only the register values of the CPU 111 but also the register values of the first to third physical devices 113a, 113b, and 113c to the RAM 112 as necessary. Specifically, if the device information acquired from the device configuration table 11e indicates the identifiers and setting values of the registers 114a, 114b, and 114c of the specific first to third physical devices 113a, 113b, and 113c that require a setting change, the device setting management unit 111c saves the values of the registers 114a, 114b, and 114c of the first to third physical devices 113a, 113b, and 113c that require a setting change in the RAM 112. Then, the device setting management unit 111c changes the setting values of the registers 114a, 114b, 114c of the first to third physical devices 113a, 113b, 113c using the identifiers and setting values indicated by the device information. Then, the device setting management unit 111c writes the saved register values of the first to third physical devices 113a, 113b, and 113c in the device configuration table 11e.

Note that this embodiment is similar to the first embodiment in that if the acquired device information indicates that no setting change is required, processing related to context switching is ended without performing a setting change of the registers 114a, 114b, and 114c of the first to third physical devices 113a, 113b, and 113c. Also, since the processing for saving and restoring the register values of the CPU 111 is the same as that of the first embodiment, detailed description thereof will be omitted.

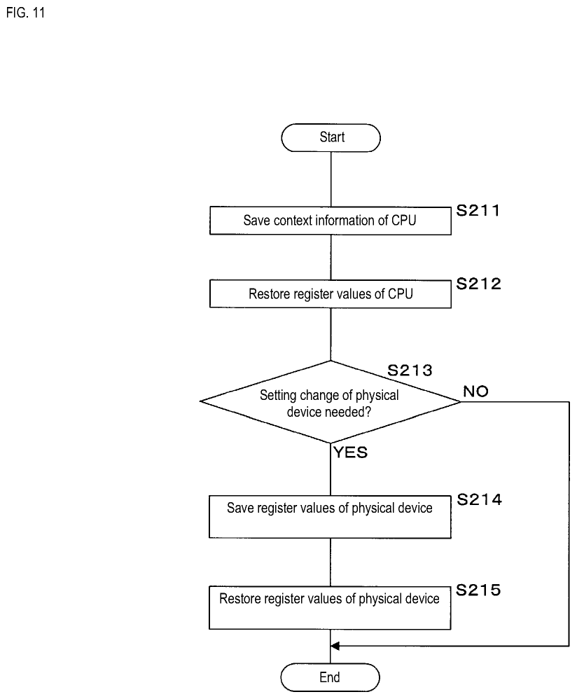

FIG. 11 is a flow chart showing the context switching processing procedure of the second embodiment. The processor 10 executes the same processing as steps S111 to S113 of the first embodiment in steps S211 to S213.

If it is determined in step S213 that any one of the first to third physical devices 113a, 113b, and 113c requires a setting change (step S213: YES), the processor 10 saves the values of the registers 114a, 114b, and 114c of the first to third physical devices 113a, 113b, and 113c that require a setting change, in the RAM 112. Specifically, the CPU 111 saves the register values by writing the values of the registers 114a, 114b, and 114c of the first to third devices 113a, 113b, and 113c that are used by the currently-operating virtual devices VM and require a setting change, in the device configuration table 11e in the RAM 112 (step S214).

Next, the processor 10 restores the register values of the first to third physical devices 113a, 113b, and 113c to be used by the virtual devices VM that are to operate after the context switching in the registers 114a, 114b, and 114c of the first to third physical devices 113a, 113b, and 113c that require a setting change (step S215), and ends the processing. Note that the register values to be restored are obtained by referring to the device configuration table 11e in the RAM 112.

According to the vehicle-mounted computer 1, the computer execution method, and the computer program 11d according to the second embodiment, even if the register values of the first to third physical devices 113a, 113b, and 113c dynamically change in addition to the CPU 111, it is possible to reduce the processing load of switching the states of the plurality of first to third physical devices 113a, 113b, and 113c accompanying the task context switching related to the plurality of virtual devices VM.

### Third Embodiment

The vehicle-mounted computer 1, the computer execution method, and the computer program 11d according to the third embodiment are different from those of the second embodiment in that the switching order of the virtual devices VM, 103 are changed so as to minimize the number of changes to the register values of the first to third physical devices 113a, 113b, and 113c used by, for example, four virtual devices VM, 103 accompanying context switching. Other configurations of the vehicle-mounted computer 1 and the like are the same as those of the vehicle-mounted computer 1 and the like according to the second embodiment, and therefore the same constituent elements are denoted by the same reference signs, and detailed description thereof is omitted.

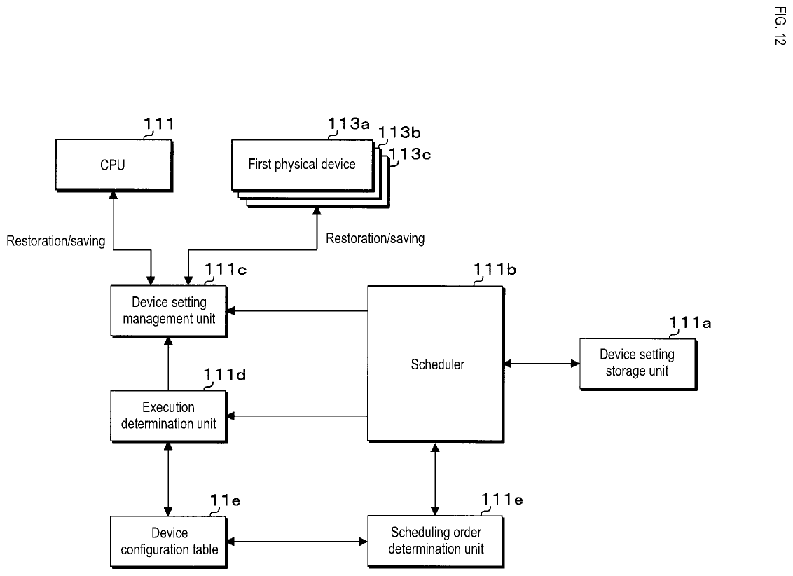

FIG. 12 is a functional block diagram relating to context switching processing according to the third embodiment. The vehicle-mounted computer 1 includes a device setting storage unit 111a, a scheduler 111b, a device setting management unit 111c, and an execution determination unit 111d as functional units as in the first embodiment, and further includes a scheduling order determination unit 111e.

The scheduling order determination unit 111e refers to the device configuration table 11e and determines the switching order of the virtual devices VM, 103 to which the hardware resources of the CPU 111 are to be allocated through time-division. Specifically, the scheduling order determination unit 111e determines whether or not the first to third physical devices 113a, 113b, and 113c to be used by the virtual devices VM, 103 after the context switching require a setting change for all candidates for the switching order of the virtual devices VM, 103, and specifies the switching order of the virtual devices VM, 103 that minimizes the number of changes to the register values of the first to third physical devices 113a, 113b, and 113c. Then, the scheduling order determination unit 111e provides the scheduler 111b with schedule information indicating the determined switching order of the virtual devices VM, 103.

The scheduler 111b acquires the schedule information output from the scheduling order determination unit 111e, and executes processing for switching the virtual devices VM, 103 through the same procedure as in the first and second embodiments, according to the switching order of the virtual devices VM, 103 indicated by the acquired schedule information. Specifically, the scheduler 111b provides the execution determination unit 111d with the first virtual device information and the second virtual device information determined by the schedule information. Also, the scheduler 111b provides the device setting storage unit 111a with the second virtual device information, inquires about the context information of the virtual devices VM, 103 indicated by the second virtual device information, and acquires the context information output from the device setting storage unit 111a. The scheduler 111b provides the acquired context information to the device setting management unit 111c.

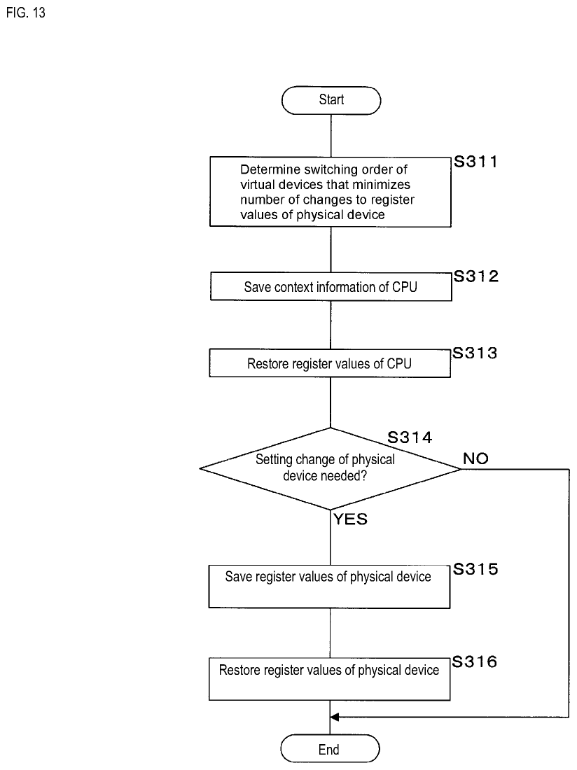

FIG. 13 is a flow chart showing a context switching processing procedure of the third embodiment. The processor 10 according to the third embodiment determines the switching order of the virtual devices VM, 103 that minimizes the number of changes to the register values of the first to third physical devices 113a, 113b, and 113c (step S311). Note that there is no particular limitation on the timing for determining the switching order.

Thereafter, the processor 10 executes the same processing as steps S211 to S215 of the second embodiment in steps S312 to S316.

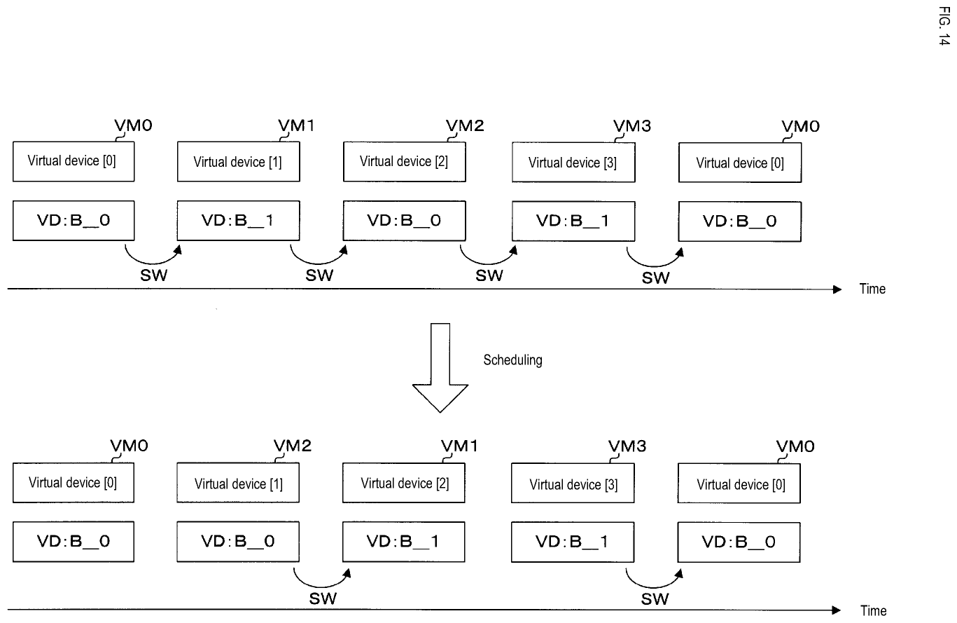

FIG. 14 is a conceptual diagram showing task switching processing according to the third embodiment. Horizontal arrows indicate the flow of time, and the upper diagram indicates that the virtual devices VM0, VM1, VM2, and VM3 are switched in this order to operate. The blocks shown below the block of the virtual devices VM indicate the setting values of the second physical device 113b that requires a setting change. In the upper diagram, the register values of the second physical device 113b are changed each time the virtual devices VM, 103 are switched in order.

The lower diagram shows the switching order of the virtual devices VM, 103 that has been changed so as to minimize the number of changes to the register values of the second physical device 113b. The switching order is such that the same register values B_0 or B_1 of the second physical device 113b are adjacent to each other, and a setting change of the register value of the second physical device 113b is needed only when switching from the virtual device VM2 to the virtual device VM1 and from the virtual device VM3 to the virtual device VM0.

In this manner, by determining the switching order of the virtual devices VM and 103 so as to minimize the number of changes to the register values of the first to third physical devices 113a, 113b, and 113c after the context switching, it is possible to efficiently perform context switching of the virtual device VM.

According to the vehicle-mounted computer 1, the computer execution method, and the computer program 11d according to the third embodiment, it is possible to efficiently perform context switching of the virtual devices VM, 103 by changing the switching order of the virtual devices VM, 103 so as to minimize the number of setting changes of the register values of the first to third physical devices 113a, 113b, and 113c.

1. A vehicle-mounted computer comprising a physical resource including a processor having a register and a plurality of physical devices each having a register, the vehicle-mounted computer generating a plurality of virtual devices by allocating the physical resource through time-division,
wherein the processor
saves a register value of the processor related to a first virtual device among the virtual devices and restores a register value of the processor related to a second virtual device among the virtual devices when switching from the first virtual device to the second virtual device,
determines whether or not it is necessary to change a register value of the physical device to be used by the second virtual device when switching from the first virtual device to the second virtual device, and
restores the register value of the physical device related to the second virtual device in the physical device if it is determined that change is necessary.

2. The vehicle-mounted computer according to claim 1, further comprising:
a device configuration table including register values to be set in the physical devices to be used by each of the plurality of virtual devices,
wherein the processor
determines whether or not it is necessary to change the register value of the physical device to be used by the second virtual device by referring to the device configuration table when switching from the first virtual device to the second virtual device, and
restores the register value of the physical device to be used by the second virtual device in the physical device if it is determined that change is necessary.

3. The vehicle-mounted computer according to claim 1, wherein if it is determined that it is not necessary to change the register value of the physical device, the processor skips processing for restoring the register value of the physical device.

4. The vehicle-mounted computer according to claim 1, wherein the processor saves a register value of the physical device to be used by the first virtual device, and restores the register value of the physical device to be used by the second virtual device, when switching from the first virtual device to the second virtual device.

5. The vehicle-mounted computer according to claim 1, wherein the processor refers to the device configuration table and determines a switching order of the plurality of virtual devices that minimizes the number of changes to the register values of the physical devices, and
the processor controls operation of the plurality of virtual devices in the determined order.

6. A computer execution method to be executed by a vehicle-mounted computer that includes a physical resource including a processor having a register and a plurality of physical devices each having a register, and generates a plurality of virtual devices by allocating the physical resource through time-division, the method comprising:
saving a register value of the processor related to a first virtual device among the virtual devices and restoring a register value of the processor related to a second virtual device among the virtual devices when switching from the first virtual device to the second virtual device;
determining whether or not it is necessary to change a register value of the physical device to be used by the second virtual device when switching from the first virtual device to the second virtual device; and
restoring the register value of the physical device related to the second virtual device in the physical device if it is determined that change is necessary.

7. A computer program for causing a vehicle-mounted computer, that includes a physical resource including a processor having a register and a plurality of physical devices each having a register and generates a plurality of virtual devices by allocating the physical resource through time-division, to execute the following processing:
saving a register value of the processor related to a first virtual device among the virtual devices and restoring a register value of the processor related to a second virtual device among the virtual devices when switching from the first virtual device to the second virtual device;
determining whether or not it is necessary to change a register value of the physical device to be used by the second virtual device when switching from the first virtual device to the second virtual device; and
restoring the register value of the physical device related to the second virtual device if it is determined that change is necessary.

8. The vehicle-mounted computer according to claim 2, wherein if it is determined that it is not necessary to change the register value of the physical device, the processor skips processing for restoring the register value of the physical device.

6. The vehicle-mounted computer according to claim 2, wherein the processor saves a register value of the physical device to be used by the first virtual device, and restores the register value of the physical device to be used by the second virtual device, when switching from the first virtual device to the second virtual device.

10. The vehicle-mounted computer according to claim 3, wherein the processor saves a register value of the physical device to be used by the first virtual device, and restores the register value of the physical device to be used by the second virtual device, when switching from the first virtual device to the second virtual device.

11. The vehicle-mounted computer according to claim 2, wherein the processor refers to the device configuration table and determines a switching order of the plurality of virtual devices that minimizes the number of changes to the register values of the physical devices, and
the processor controls operation of the plurality of virtual devices in the determined order.

12. The vehicle-mounted computer according to claim 3, wherein the processor refers to the device configuration table and determines a switching order of the plurality of virtual devices that minimizes the number of changes to the register values of the physical devices, and
the processor controls operation of the plurality of virtual devices in the determined order.

13. The vehicle-mounted computer according to claim 4, wherein the processor refers to the device configuration table and determines a switching order of the plurality of virtual devices that minimizes the number of changes to the register values of the physical devices, and
the processor controls operation of the plurality of virtual devices in the determined order.
